(19) United States
(12) Patent Application Publication
(10) Pub. No.: US 2015/0242911 A1
(43) Pub. Date: Aug. 27, 2015

(54) GROUP CHECK IN

(71) Applicant: eBay Inc., San Jose, CA (US)

(72) Inventor: Matthew Scott Zises, San Jose, CA (US)

(73) Assignee: eBay Inc., San Jose, CA (US)

(21) Appl. No.: 14/189,073

(22) Filed: Feb. 25, 2014

(51) Int. Cl. G06Q 30/06; G06Q 30/02

(52) U.S. Cl. CPC G06Q 30/0605; G06Q 30/0267

(57) ABSTRACT

Systems and methods are provided for facilitating group shopping using group check-in. A plurality of users may check in at a location such as a service provider location. The plurality of users may check in using beacons or social media. A system may determine a relationship between two or more of the plurality of users and identify a group that has checked in to the service location. Products, services, and/or targeted assistance guidelines may then be determined for each identified group. A group may be a family, a couple, a team, a club, or other group of people. The products and/or services may be targeted for each group based on market research and/or user information of members of the group. The system may facilitate group payment for items purchased by one or more members of the group.

### TECHNICAL FIELD

The present invention generally relates to electronic commerce and, more particularly, to systems and methods for facilitating group shopping.

### BACKGROUND

Users may visit locations to engage in transactions. For example, a user may visit a merchant to purchase a product or a service, browse for products or services, or attend events during which products or services are sold. Services for users and product offers for users are commonly directed to all of the patrons that enter a merchant location. In some situations, advertising or displays at the merchant location are designed to appeal to a particular type of customer such as adults, children, men, or women. However, these types of advertisements or displays are not responsive to the actual user or group of users that enters the merchant location. This can be a disadvantage for both the user(s) and the merchant as potentially useful or interesting products or services may go unnoticed by the user(s) and potential sales for the merchant can be missed.

It would therefore be desirable to be able to provide systems and methods for facilitating a user-specific shopping experience such as a group shopping experience.

### BRIEF DESCRIPTION OF THE DRAWINGS

FIG. 1 is a block diagram of a networked system suitable for implementing group shopping processes, according to an embodiment.

FIG. 2 is a flowchart of an exemplary process to provide targeted products and services for a group of users upon group check-in, according to an embodiment.

FIG. 3 is a flowchart of an exemplary process for identifying a group and determining product and service offers for the group, according to an embodiment.

FIG. 4 is a flowchart of an exemplary process for facilitating group payment for a purchased product or service, according to an embodiment.

FIG. 5 is a block diagram of a computer system suitable for implementing one or more components in FIG. 1, according to an embodiment.

FIG. 6 is a flowchart of an exemplary process for modifying and/or updating product and service offers when a checked-in user becomes a member of a checked-in group, according to an embodiment.

FIG. 7 is a flowchart of an exemplary process for modifying and/or updating product and service offers when one or more members of a checked-in group leaves the group, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Various locations provide short range wireless communications with a user device, such as through Bluetooth Low Energy (BLE) beacon communications. These beacons may be set up at a location and communicate with the user device to alert users of check-in services through their user device. The beacons may provide additional functionality, such as establishing a connection with a server entity to complete transactions, including check-in services. Additionally, the beacons may provide communication services to the user device directly, including information stored on the beacons, and/or information from a device or server corresponding to the beacon.

A service provider may include one or more locations where the service provider offers goods, products, services, or other items to users. The service location(s) may utilize short range wireless beacons to communicate with mobile user devices of the users. The short range wireless beacons may employ BLE communications that emit a signal receivable by a user device. The communication may include an identifier for the beacon. A user device may passively monitor for BLE communications. When a user device detects a BLE signal and verifies the identifier as belonging to a particular location such as a venue (e.g., a venue device and/or server), both the user device and the beacon may ramp up in power and establish a connection. The connection may further enable the user device to communicate with a service provider device and/or server. The beacon may be connected to a networked device at the service location, or the beacon may include network functionality to communicate with the service provider server.

The service provider may utilize an identifier from each user device to determine a user history and/or other information for the associated user. Thus, each user may receive targeted assistance based on the user history and other information, such as information about the service location and/or service provider, offers for help, product offers, services offers, and similar assistance or offers.

When more than one user is checked into a service location, the user histories and/or other information of each user may be used to determine one or more relationships between the checked-in users. The determined relationships may be used to identify one or more groups such as couples, families, teams, organizations, clubs, or other groups that are checked in to the service location. The relationships between checked-in users may be determined based on previously registered group information (e.g., information provided to the system by a plurality of users identifying themselves as a group and, if desired, receiving a group identifier) or based on information associated with each of the users (e.g., email information, social media information, account information, purchase history information, or other user information) obtained by the system before, during or after check-in of the users.

The group identifications may be utilized to offer a variety of targeted assistance types, targeted products, and/or targeted services to a checked-in group. For example, one or more products and/or services that may be of particular interest for the group or for which a sale may be more likely if multiple members of the group are present (e.g., to decide whether to purchase the product and/or service) may be offered to a checked-in group.

In various scenarios, as each user arrives at a service location, wireless beacons may establish a communication channel with a user device that the user possesses. The wireless beacons may be located at or nearby the service location. As examples, the wireless beacons may be located at an entrance to the service location, a parking lot of the service location, or residing on or near transportation services to the service location (e.g., a train or an airplane arriving at the service location). Establishment of a, communication channel may trigger an application on each user device to check the associated user in to that location and, for example, transmit a user identifier to the beacon. However, this is merely illustrative. In various embodiments, one or more users may utilize other means to check in to a service location. For example, the user can check into a service location by opening a check-in application such as a social media application on the user device themselves, by accessing a check-in service on a website such as a social media website or by otherwise checking in to the service location. The check-in application or the beacon may then communicate a user identifier associated with that user (e.g., a user device identifier) to a server. The server may then access user information such as user history information or other user information using the user identifier.

In one example usage scenario, an engaged couple may check in to a service location and, responsive to identifying that the engaged couple is checked in, a service location may offer wedding-related items (e.g., engagement rings, wedding dresses, tuxedos, limousine rentals, honeymoon travel packages, etc.) to the couple. This can be particularly advantageous for both a merchant and a customer since the energy and time of a salesperson and the engaged couple can be used efficiently to make decisions and purchases while both members of the couple are present.

In another example usage scenario, a female member of the engaged couple may check in to the same or another service location with one or more members of her bridal party. Responsive to identifying that some or all of the bridal party is checked in, a service location may offer bridal party related items (e.g., bridesmaids clothing, personalized shirts, bachelorette party items, etc.) to the bridal party.

In another example usage scenario, at a restaurant, a system may determine, based on group check-in information that a member of a partially checked-in party that is waiting to be seated is in proximity to the restaurant (e.g., coming in from the parking lot and will be there very shortly) and notify a restaurant host to prepare a table and/or prepare to seat the party.

In other example usage scenarios, at a car dealership, sports cars may be offered to a group of two or more middle-aged men and/or minivans or sport utility vehicles may be offered to a family with children. In other example usage scenarios, at a sports event, a group of male friends under 30 years of age may be offered a beer package or a team apparel package and/or a married couple may be offered a seat upgrade.

In other example usage scenarios, at an airport, groups of passengers may be directed to group-specific security checkpoints such as family checkpoints experienced with family groups and family-related luggage (e.g., strollers and carry-alls), male checkpoints staffed with male security personnel, female checkpoints staffed with female personnel, frequent traveler checkpoints, or other group-specific security checkpoints.

In another example usage scenario, on a tour such as a guided tour, group check-in information for the members of a tour group may be used to the track members of the tour group so that tour information and/or bus, plane, train, or boat departures can proceed only when all members of the group are present (e.g., checked in to a beacon carried by the tour guide or a tour vehicle) and so that a lost or otherwise separated member of the group can be located (e.g., by tracking the user device of the separated member). In another example usage scenario, group check-in information may be used to prevent separation of family members by notifying, for example, one or more parents of a child in a checked-in family group that a child is leaving the store without the rest of the family.

In another example usage scenario, a sports team may check into a soccer stadium and the system may identify the checked-in team and offer a team discount for future events. This can be particularly advantageous because all members of the team are present (e.g., checked in) for planning and coordination of schedules to attend. In some scenarios, the personal calendars of each member of the team can be accessed by the system and used to provide team discounted offers for future events for which all team members are available. Identifying checked-in groups at various locations in these ways can therefore provide various advantages for both users and service providers as described herein.

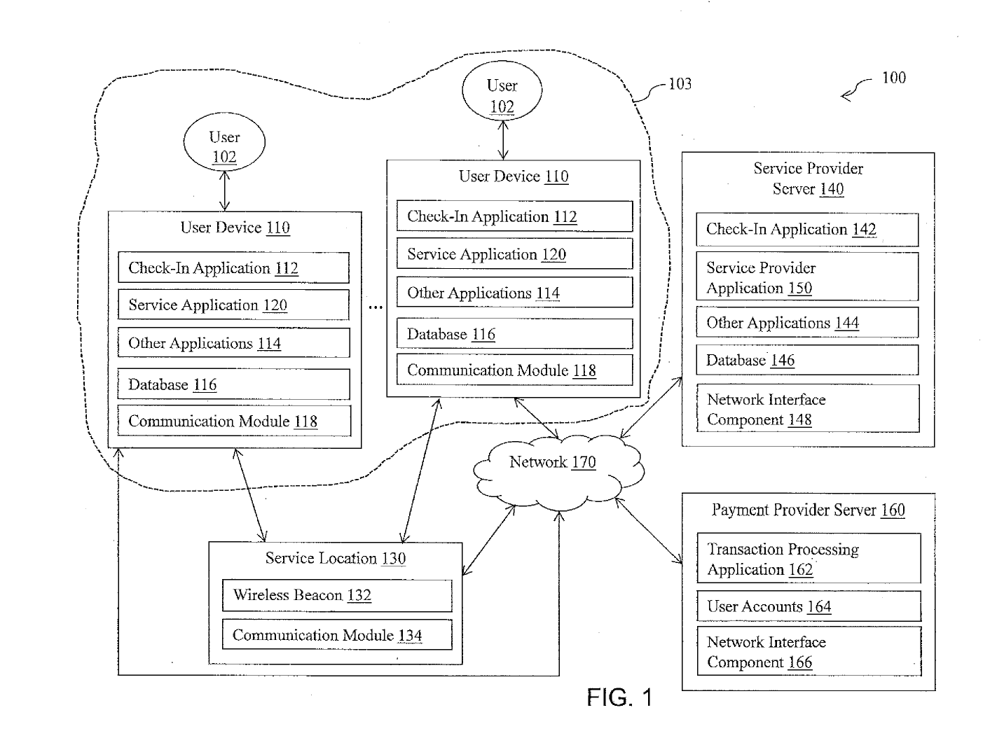

FIG. 1 is a block diagram of a networked system 100 suitable for implementing group check-in and related group shopping processes, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 may include one or more users 102, each having a user device 110, a service location 130, a service provider server 140, and a payment provider server 160 in communication over a network 170. Each user 102 (e.g., a visitor to a service location), may utilize their corresponding user device 110 to check-in to service provider server 140. Service location 130 may correspond to a location that provides goods, products, item, and/or other services to a user including travel, medical, or other services. Service provider server 140 may correspond to a general server for multiple service locations (e.g. a server for a merchant chain) or may be specific to only service location 130 (e.g. a server for a hospital, airport, etc.).

Check-in of users 102 may be accomplished through a wireless beacon 132 at service location 130, through a social media application or website or by other check-in equipment. Once one or more users 102 are checked-in to service provider server 140, a group 103 of users may be identified. For example, a user history of each user 102 (e.g., a purchase history of the user or a visit history of the user at service location 130 or other services locations) or other user information may be determined for that user. The user history and/or other information of the users may be used to determine that one or more users 102 form a group such as group 103. Group 103 may be a family group, a group of friends, a couple, siblings, cousins, a sports team, a club, an organization or other suitable group of people. Once a group 103 has been identified, the identified group may then receive targeted assistance, product and/or service offers based on the group identification.

User devices 110, service location 130, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Each user device 110 may be implemented using any appropriate hardware and software such as hardware and software configured for wired and/or wireless communication with wireless beacon 132 and service provider server 140. For example, in one embodiment, user device 110 may be implemented as a personal computer (PC), a smart phone, personal digital assistant (FDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although two users and two associated user devices are shown in FIG. 1, a group 103 may include any number of users each having one or more user devices. System 100 may include users and user devices that are independent of a group. Although only one group 103 is shown in FIG. 1, a plurality of groups such as group 103 may be included in system 100.

Each user device 110 of FIG. 1 contains a check-in application 112, a service application 120, other applications 114, a database 116, and a communication module 118. Check-in application 112, service application 120, and other applications 114 may correspond to processes, procedures, and/or applications executable by a hardware processor, for example, a software program. In other embodiments, user device 110 may include additional or different software as required.

Check-in application 112 may be used by the user 102 of each user device 110 to establish a connection between that user device 110 and service provider server 140. Check-in application 112 may correspond to a specific application utilized by user device 110 with service provider server 140 to complete a check-in with service provider server 140. The check-in with service provider server 140 may correspond to a process to log in to a user account of user 102 with service provider server 140. In other embodiments, the check-in may provide and/or verify identity of user 102, including transmission of an identifier for user 102 and/or user device 110. The check-in may be completed over network 170 with service provider server 140. In such embodiments, check-in application 112 may correspond more generally to a browser application configured to communicate with service provider server 140.

Check-in application 112 may also correspond to an application available over the Internet for download from service provider server 140 and/or other server corresponding to service location 130. Check-in application 112 may be set up to receive short range wireless communications with wireless beacon 132 at service location 130 to complete a check-in process. For example, service location 130 may include infrastructure with wireless beacon 132 to communicate with user device 110 and complete the check-in process with service provider server 140. Wireless beacon 132 may be configured to transmit an identifier for reception by user device 110, as will be explained in more detail herein.

Check-in application 112 may execute in the background of an operating system of each user device 110 and be configured to establish connections, using communication module 118 of that user device 110, with wireless beacon 132 at service location 130. The connection may be established with or without user input from user 102. For example, wireless beacon 132 may broadcast a token, such as a universally unique identifier (UUID), for reception by check-in application 112, as will be explained in more detail herein. Check-in application 112 may utilize communication module 118 of the user device 110 to receive the token from wireless beacon 132. If check-in application 112 acknowledges the UUID as identifying service location 130, wireless beacon 132, and/or service provider server 140, check-in application 112 may transmit an identifier corresponding to a user 102 and/or a user device 110 back to wireless beacon 132. Check-in application 112 may utilize communication module 118 to communicate with wireless beacon 132 (e.g., over near field communication, Bluetooth, Bluetooth Low Energy, radio, infrared, or other connection). The identifier from each user device 110 may include, be transmitted with, concatenated with, or otherwise bundled with the identifier received from wireless beacon 132.

Once a connection is established with wireless beacon 132, each user device 110 may be checked-in with service provider server 140 if the user 102 of that device has not previously been checked-in. The check-in process may then associate that user 102 with wireless beacon 132 used to check-in that user 102. In such embodiments, check-in application 112 of each user device 110 may utilize short range wireless communication with wireless beacon 132, such as near field communication, Bluetooth, Bluetooth Low Energy, radio, infrared, or other connection. Where wireless beacon 132 corresponds generally to service location 130, each user 102 may be associated with service location 130. However, in other embodiments wireless beacon 132 may correspond to a location, item (i.e., a product or good), and/or service at service location 130. Thus, each user 102 may be associated with that location, item, and/or service (e.g., a television sales section of a merchant, a departure area of an airport, a neonatal section of a hospital, etc.).

Check-in application 112 may receive information from service provider server 140. For example, check-in application 112 may receive information, maps, processes to request assistance from the service provider, etc. The information may be passed to check-in application 112 generally based on service location 130, such as a map of a store/airport or generally information about service location 130. Additionally, the service provider server 140 may determine a user history and/or other user information corresponding to each user 102 from a user identifier transmitted to service provider server 140 during the check-in process, as will be explained in more detail herein. Thus, the information may transmitted to user 102 based on the user history and/or the other user information. Since user 102 is already checked-in with service provider server 140, service provider server 140 may know an identifier of user device 110 and transmit the information to user device 110 using that identifier over network 170 and/or through one of wireless beacon 132.

Check-in application 112 may utilize communication module 118 to pass user information to service provider server 140, including user assistance preferences, user calendar information, user relationship information, user email information, user social media information, user group membership information, user family information, user team information, identifiers of user 102 and/or user device 110, a request for assistance, a request for a type of assistance, product preference information, service preference information, etc. Once check-in application 112 of each user device of group 103 has completed a connection with service provider server 140, the group may be recognized or identified by service provider server 140 and group 103 may receive targeted assistance, product offers and/or service offers for that group.

Service application 120 may be used, for example, to provide a convenient interface to permit users 102 of group 103 to receive, request, and/or view targeted products and/or services. Service application 120 may correspond to an application specific to service location 130 and/or service provider server 140, such as an application downloadable over network 170 and/or through wireless beacon 132. However, in other embodiments, service application 120 may correspond more generally to any application configured to receive targeted assistance, product offers, and/or service offers, including a browser application.

Service application 120 may be configured to receive assistance, products offers, and/or service offers for service location 130. Service application 120 may also be configured to display the information. For example, service application 120 may display general information for service location 130, such as a map, merchant store offerings, group-specific product or service locations, information desk locations, sales/coupons/rebates, or other general information. Additionally, service application 120 may use a location device and/or application of user device 110, such as a GPS device and application, to locate users 102 of group 103 at a specific location service location 130, and transmit the specific location to service provider server 140 for use in providing the targeted assistance, product offers and/or service offer. In other embodiments, the locations of users 102 in group 103 may be determined based on a check-in of user device 110 with wireless beacon 132.

Where the targeted assistance, products, and/or services may be provided to group 103 face to face by a salesperson, concierge, or other employee of service location 130, service application 120 may be configured to request the assistance in the preferred language of group 103 or according other group preferences or attributes (e.g., a male or female assistance, an employer preference, a disability needs preference, etc.). Group service preferences may be provided by one or more of users 102 (e.g., through typing in a preference request, selection of available preferences, and/or selection of preferences determined from user identifiers transmitted on check-in of group 103) or may be learned by service application 120 or service provider server 140. Service application 120 may also receive group preference and/or group membership information by scraping one or more online accounts of users 102 (e.g., a social networking account, a microblogging account, a user account with another service provider, etc.).

In various embodiments, check-in application 112 and service application 120 may be incorporated in the same application so as to provide their respective features in one convenient application interface.

Each user device 110 may include other applications 114 as may be desired in particular embodiments to provide features to user device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications. Other applications 114 may include browser and/or mapping applications where the functions are not provided by check-in application 112 and/or service application 120. Other applications 114 may contain software programs, executable by a processor, including a graphical user interface (GUI) configured to provide an interface to the user.

Each user device 110 may further include memory such as database 116 which may include, for example, identifiers such as operating system registry entries, cookies associated with check-in application 112, service application 120, and/or other applications 114, identifiers associated with hardware of user device 110, or other appropriate identifiers, such as identifiers used for payment/user/device authentication or identification. Database 116 may include user device tokens and/or encryption keys, including a public key of service location 130 and/or service provider server 140 for wireless beacon 132. Database 116 may include identifying information for tokens enabling check-in application 112 to identify wireless beacon 132 when receiving a corresponding token. In one embodiment, identifiers in database 116 may be used to associate user device 110 with a particular account maintained by the account provider. Database 116 may further include online account access information.

Each user device 110 may include a communication module 118 adapted to communicate with wireless beacon 132, service provider server 140, and/or payment provider server 160. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with wireless beacon 132 without network 170 using short range wireless communications.

Service location 130 may correspond to a physical location visited by group 103 that offers targeted assistance, targeted products, and/or targets services to group 103. For example, service location 130 may correspond to merchant storefronts, shopping malls, amusement parks, concert halls, sports arenas, museums, hospitals, airports, train stations, etc. Service location 130 may include a plurality of locations within service location 130, where each location includes a wireless beacon. For example, a location in service location 130 may correspond to an area of a store offering video games for sale. Wireless beacon 132 may check-in group 103 when user devices 110 of one or more members 102 are in proximity to wireless beacon 132. Thus, wireless beacon 132 enable service provider server 140 to associate group 103 with service location 130 and/or a location within service location 130. Service location 130 may be one of a plurality of locations corresponding to service provider server 140. However, in other embodiments, service provider server 140 may correspond only to service location 130. Service location 130 may include a wireless beacon 132 and a communication module 134. In other embodiments, service location 130 may include additional or different software and devices as required.

Wireless beacon 132 may be maintained, for example, by service location 130 and service provider server 140. Wireless beacon 132 may be implemented using any appropriate hardware and software configured for wireless communication with user device 110. For example, in one embodiment, wireless beacon 132 may be implemented as a dongle device including a hardware processor and a communication module, for example, connected to device at service location 130. Thus, wireless beacon 132 may be implemented as a device incorporated within or attached to a personal computer (PC), a smart phone, personal digital assistant (PDA), laptop computer, and/or other types of computing devices capable of transmitting and/or receiving data, such as an IPAD® from APPLE®. Wireless beacon 132 may also act as a stand-alone device including a processor, communication module, and/or network interface component configured to communicate with user device 110 and/or service provider server 140. Although a single beacon is described, a plurality of wireless beacons may be utilized and be location specific within service location 130, as previous discussed.

Wireless beacon 132 of FIG. 1 may include processes, procedures, and/or applications executable by a hardware processor, for example, a software program, configured to interact with user devices 110. Wireless beacon 132 may include applications for transmitting requests to establish a connection between a user device and wireless beacon 132. Thus, wireless beacon 132 may utilize a low energy short range wireless communication of wireless beacon 132 to transmit requests to establish a connection with user devices 110, including an identifier such as a Universally Unique Identifier (UUID). If user devices 110 receive a request to establish the connection with wireless beacon 132 and respond with a user device identifier (potentially including the UUID and other information to effectuate a check-in of each user device 110), wireless beacon 132 may ramp up in power and create a connection between user devices 110 and wireless beacon 132.

Wireless beacon 132 may transmit the request to establish the connection with wireless beacon 132 as a short range communication (e.g. a BLE protocol communication) including a “wake up” process for check-in applications 112 of user devices 110 and/or a token for wireless beacon 132 or service provider server 140. In other embodiments, the request and/or connection may utilize near field communication, radio communication, infrared communication, or Bluetooth communication. The request may be specific to each user device 110 by including information that is specific to the corresponding user 102 or a group of users, such as a name, identifier, or user device identifier. The information specific to user 102 or a group of users may be determined from user accounts of users 102 or other information previously provided to service provider server 140. Thus, in certain embodiments, only one or more specific user devices 110 will pick up and authenticate the request.

After wireless beacon 132 receives user device identifiers from user devices 110 of users in group 103, wireless beacon 132 may determine that group 103 is at or in proximity to service location 130. Wireless beacon 132 may pass the user device identifiers or an associated group identifier to service provider server 140 to complete the check-in process and associate group 103 with service location 130. As shown in FIG. 1, wireless beacon 132 utilizes communication module 134 to pass the information to service provider server 140. However, in other embodiments, wireless beacon 132 may utilize a network connection of wireless beacon 132 through a communication module of wireless beacon 132. Additionally, wireless beacon 132 may keep a communication channel open between user devices 110 and service provider server 140 for passing additional information, such as assistance requests, assistance preferences, product and/or service offers, transaction information, payment information, and/or identification information.

In various embodiments, service location 130 includes at least one communication module 134 adapted to communicate with user devices 110, service provider server 140, and/or payment provider server 160. Communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 134 may communicate directly with user device 110 without network 170 using short range wireless communications.

Service provider server 140 may be maintained, for example, by a service location including one or a plurality of service locations. Generally, service provider server 140 may be maintained by anyone or any entity that establishes and/or maintains a location with services offered to users. In this regard, service provider server 140 may include one or more applications, which may be configured to interact with user devices 110 and/or service location 130 to complete check-in processes for user devices 110. Although only one service provider server is shown, a plurality of service provider servers may be utilized. In various embodiments, the check-in and assistance features of service provider server 140 may also be offered by payment provider server 160. Thus, all or part of the described features and processes of service provider server 140 may be incorporated within payment provider server 160.

Service provider server 140 may include a check-in application 142, a service provider application 150, a database 146, and a network interface component 148. Check-in application 142 and service provider application 150 may correspond to processes, procedures, and/or applications executable by a hardware processor, for example, a software program. In other embodiments, service provider server 140 may include additional or different software as required.

Check-in application 142 may correspond to processes to complete check-in with user devices 110. Thus, check-in application 142 may correspond to the server side application of service provider server 140 configured to transmit and/or receive check-in requests from user devices 110 and complete the check-in requests. A check-in request may include log-in information for a user account in database 146. Check-in may be completed by verifying the account information. However, in embodiments where a user account has not been previously established by user 102 and/or service provider server 140 does not offer user account services, check-in application 142 may receive other information for identifying users 102 and group 103, such as user names/identifiers, user device identifiers, group identifiers, an identifier for an account with another server (e.g., a payment account/payment account identifier with payment provider server 160), or other information.

Once check-in is completed between group 103 and service provider server 140, check-in application 142 may be utilized to associate group 103 with a location corresponding to wireless beacon 132, such as service location 130 generally, or a sub-location of service location 130 corresponding to wireless beacon 132. Additionally, check-in application 142 may check group 103 out of the location when group 103 or one or more users 102 of the group leaves the proximity of wireless beacon 132. For example, when group 103 leaves the proximity of wireless beacon 132 so that one or more user devices 110 of the group members are no longer in communication with wireless beacon 132, group 103 may be checked-out of the location.

Check-in application 142 may receive user identifiers from user devices 110 and/or a group identifier of group 103. The user identifiers may be utilized to check-in group 103. Additionally, the user identifiers may be passed to service provider application 150 to determine and provide targeted assistance, product and/or services to group 103.

Service provider server 140 further includes service provider application 150 configured to receive information corresponding to group 103 checked-in to wireless beacon 132 through service location 130 and provide targeted assistance, products and/or services to group 103. In this regard, service provider application 150 may receive group check-in information such as a group identifier and/or other information for group 103. Utilizing this group check-in information, service provider application 150 may determine and provide product and/or service offers to group 103.

The group check-in information may also correspond to one or more user accounts of users 102 in group 103 with another server, such as payment provider server 160. In such embodiments, service provider server 140 may determine a user history and/or a group history from information received from payment provider server 160. Payment provider server 160 may provide information about previous purchases/visits by group 103 at the same or similar locations to service location 130 or may provide other info nation.

In various embodiments, service provider server 140 may include other applications 144 as may be desired in particular embodiments to provide features to service provider server 140. For example, other applications 144 may include security applications for implementing server-side security features, programmatic server applications for interfacing with appropriate application programming interfaces (APIs) over network 170, or other types of applications. Other applications 144 may contain software programs, executable by a processor, including a graphical user interface (GUI), configured to provide an interface to a user.

Service provider server 140 may include a database 146 which may include, for example, identifiers such as operating system registry entries, cookies associated with check-in application 142 and/or service provider application 150, identifiers associated with hardware of service provider server 140, or other appropriate identifiers, such as identifiers used for payment/user/device authentication or identification. Database 146 may include identifiers and/or user accounts of user 102, which may comprise an identifier for users 102, group 103, and/or user devices 110. In various embodiments, identifiers in database 146 may be used by a payment/credit provider, such as payment provider server 160, to associate users 102 and/or group 103 with a particular account maintained by payment provider server 160. For example, an identifier for a payment account with payment provider server 160 may be stored with a user account, group account, identifier of group 103, and/or identifiers of users 102 in database 146. In other embodiments, a user account stored in database 146 may include a shared identifier with the payment account with payment provider server 160.

In various embodiments, service provider server 140 includes at least one network interface component 148 adapted to communicate with user devices 110, service location 130, and/or payment provider server 160 over network 170. In various embodiments, network interface component 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices

Payment provider server 160 may be maintained, for example, by an online payment service provider, which may provide user account and payment services on behalf of users 102, group 103 and other users. In this regard, payment provider server 160 includes one or more processing applications, which may provide payment for items using a user account with payment provider server 160. In one example, payment provider server 160 may be provided by PAYPAL®, Inc. of San Jose, Calif., USA. However, in other embodiments, payment provider server 160 may be maintained by or include a merchant, financial services provider, and/or other service provider, which may provide user account services to user 102. Although payment provider server 160 is described as separate from service provider server 140, it is understood that payment provider server 160 may include services offered by service provider server 140 and vice versa.

Payment provider server 160 of FIG. 1 may include a transaction processing application 162, a database of user accounts 164, and a network interface component 166. Transaction processing application 162 may correspond to processes, procedures, and/or applications executable by a hardware processor, for example, a software program. In other embodiments, payment provider server 160 may include additional or different software as required.

Transaction processing application 162 may be configured to receive information from one or more user devices 110 and/or service provider server 140 for processing and completion of financial transactions. Transaction processing application 162 may include one or more applications to process financial transactions between user devices 110 and/or service provider server 140. Financial transactions may include financial information corresponding to user debit/credit card information, checking account information, a user account (e.g., payment account with payment provider server 160), or other payment information. Transaction processing application 162 may complete the financial transaction for the purchase request by providing payment to service provider server 140. In various embodiments, transaction processing application 162 may provide transaction histories, including receipts, to user devices 110 in order to provide proof of purchase for an item and/or service. Transaction processing application 162 may also provide the transaction histories to service location 130 for use in pick-up/delivery of the item and/or service.

Additionally, payment provider server 160 includes user accounts 164. As previously discussed, users 102 and/or group 103 may establish one or more user accounts and/or group accounts with payment provider server 160. User accounts 164 may include user information, such as name, address, birthdate, payment/funding information, additional user financial information, and/or other desired user data. Information in user account 164 may be utilized by service provider server 140 to determine and provide targeted assistance, product offers, and/or services offers to group 103

In various embodiments, payment provider server 160 may include at least one network interface component 166 adapted to communicate with user device 110, service location 130, and/or service provider server 140 over network 170. In various embodiments, network interface component 166 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

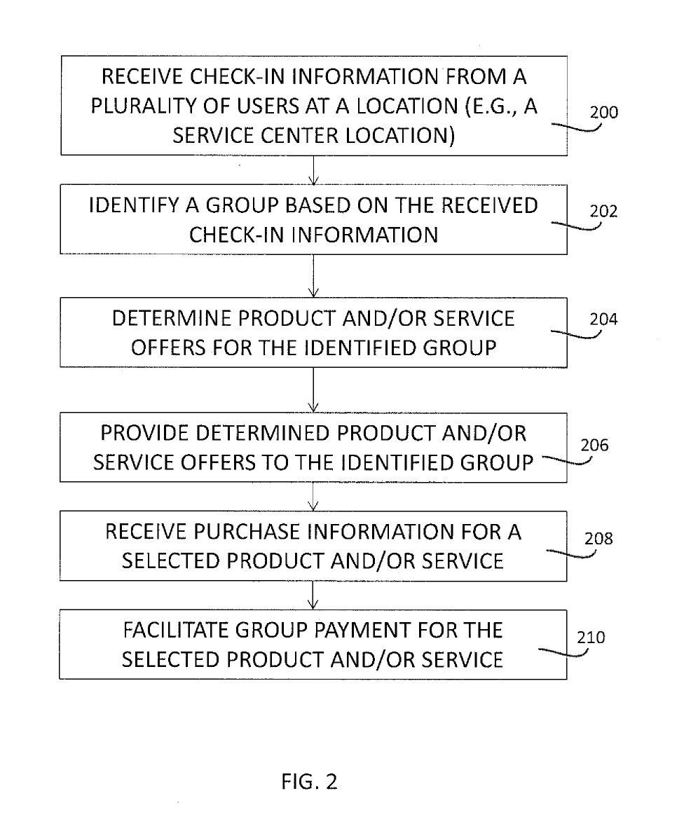

FIG. 2 is a flowchart of an exemplary process to provide targeted assistance, products, services, product offers, and/or service offers based on group check-in, according to an embodiment.

At step 200, check-in information may be received from a plurality of users at a location (e.g., a service center location). Check-in information from each user may include at least a user identifier for that user. The check-in information from each user may be provided through a social media application or website or may be received from a beacon corresponding to the location when a user device of that user is in communication with the beacon. The user device may be in communication with the beacon when the user device is in proximity to the beacon. The user device and the beacon may be in communication using one of near field communication, radio communication, infrared communication, Bluetooth communication, and Bluetooth low energy communication.

The check-in information may be received from each of the plurality of users when that user arrives at the location. In some embodiments, check-in related products, services, and/or recommendations may be provided to each individual user when that user checks in.

At step 202, one or more groups may be identified based on the received check-in information. The groups may be identified based on user information associated with at least some of the plurality of users at the location that indicates that two or more of the plurality of users are a group or a potential group. In some embodiments, a group (or a potential group) may be identified based, in part, on the times and/or locations at which two or more of the plurality of users arrives at the location. For example, two or more users may arrive at a location together at a common time and enter the location through a common doorway. The two or more users may be identified as a group based at least in part on a determination that they arrived together. In another example, two users may arrive at a location together and a third user that is known or determined to have a relationship with one or both of the two users may arrive at the location at a different time and/or through a different doorway. The two users and the third user may be identified as a potential group (and provided with a group check-in recommendation) or the system may determine that, despite the known or determined relationship between the users, the users do not constitute a group at that location at that time. A potential group may be identified as a group if one or more of the users that have been provided with the group check-in recommendation confirms (e.g., using a mobile device of the user) that the potential group desires group check-in.

At step 204, one or more product and/or service offers and/or targeted assistance guidelines may be determined for the identified group. For example, the identified group may be a married couple that has checked in and products, services, and/or targeted assistance guidelines for married couples may be determined. Products, services, and/or targeted assistance guidelines for married couples may include dish sets, home goods, child care products, travel products, house cleaning services, or other products or services known to be of interest to married couples. In another example, the identified group may be a college basketball team that has checked in and products, services, and/or targeted assistance guidelines for college sports teams may be determined. Products, services, and/or targeted assistance guidelines for college sports teams may include matching clothing, logoed items for that team, or other items such as items that might require the presence of the entire team for purchase decisions such as team uniforms. In another example, at a car dealership, an identified group may include two middle-aged men that have checked in and it may be determined that a sports car offer may be likely to be accepted by that identified group and/or the identified group may include a family that has checked in and it may be determined that a minivan or a sports utility vehicle offer may be likely to be accepted by that identified group. In another example, in situations in which it is inconvenient or impossible for all members of a group to be served at the same time (e.g., for appointment-related services such as counseling appointments, doctor appointments, government services, or hair stylist appointments or for services in which individuals or subgroups may be served based on their place in a line such as waiting to board an airplane, a train, or an amusement park ride), a group may be provided with a staggered check-in process (e.g., a process in which one or more members of the group gets checked in periodically such as every minute, every five minutes, or every ten minutes).

At step 206, the determined products, services, and/or targeted assistance may be provided to the identified group (e.g., the checked-in group). The determined products, services, and/or targeted assistance may be provided by a person (e.g., a salesperson, a service employee, etc.) to one or more members of the checked-in group or may be offered electronically via one or more user devices of the members of the checked-in group.

At step 208, purchase information for a selected product and/or service may be received. The purchase information may include a request from one or more group members to purchase one or more of the offered products and/or services. The purchase information may be transmitted through a service provider server or using a user device of one or more members of the checked-in group.

At step 210, the system may facilitate group payment for the selected product.

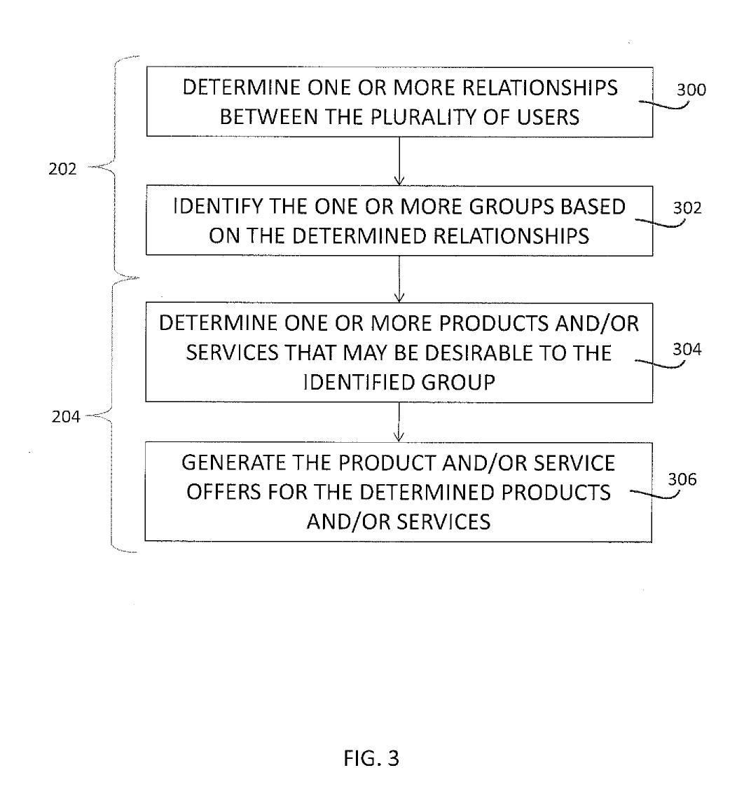

FIG. 3 shows additional illustrative steps that may be performed for identifying a group using check-in information from a plurality of users at a location and for determining a product and/or service offer and/or targeted assistance guidelines for an identified group as described above in connection with steps 202 and 204 of FIG. 2.

At step 300, one or more relationships between one or more of the plurality of users may be determined. Determining the one or more relationships may include obtaining information about each of the plurality of users (e.g., from user accounts associated with a service provider server or a payment server or from social media and/or email accounts of the users). The obtained information may be used to determine that two or more of the plurality of users are related by blood (e.g., are family members), are related by marriage, are engaged to be married, are friends, belong to a common organization such as a club or a team or belong to another group.

At step 302, one or more groups may be identified based on the determined relationships. The identified groups may include a married couple, a couple, a family, a family group, a group of friends, a club, a team, or other groups as, for example, described herein. In some embodiments, a group may be identified based on the determined relationships and additional information such as potential group confirmation information provided by one or more of the users, user arrival time information, and/or user arrival location information.

At step 304, one or more products and/or services may be determined that may be desirable to the one or more identified groups. These group-specific desirable products or services may include wedding or honeymoon products or services for an engaged couple, team apparel for a sports team, or other products and/or services that are known based on market research and/or group-specific information to be desirable to the identified groups. The group-specific services may include staggered check-in services as, for example, described herein.

At step 306, offers for the product and/or service offers may be generated for the determined products and/or services. Generating the offers may include electronically transmitting product and/or service information and associated prices electronically to user devices of the members of the identified groups and/or transmitting product and/or service information and associated prices electronically to a sales representative at the location to be provided in person to the group.

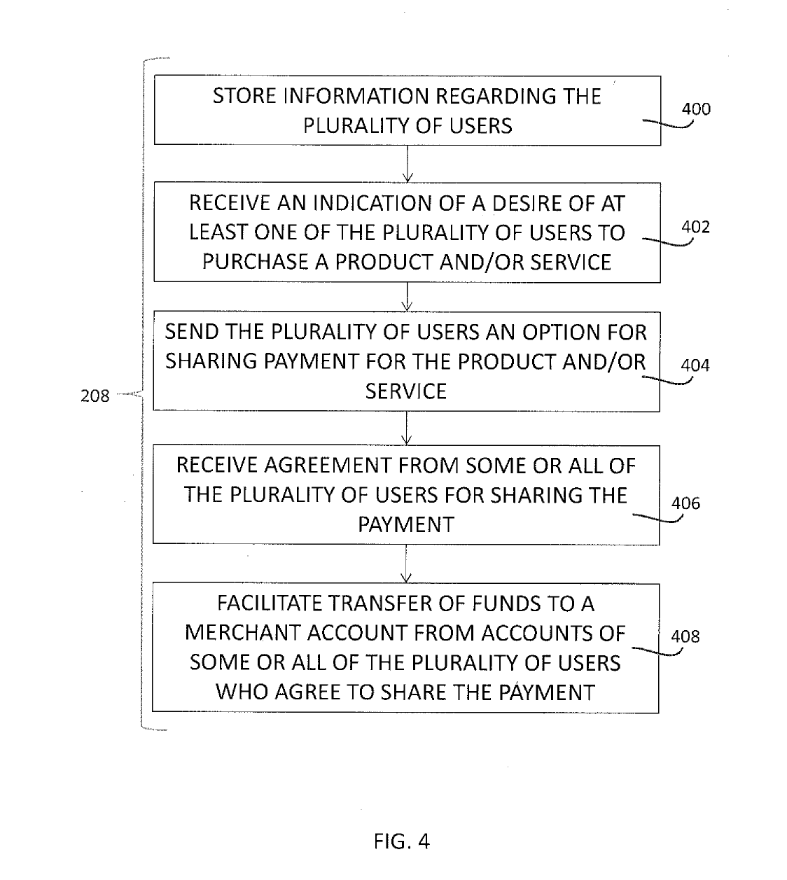

FIG. 4 shows additional illustrative steps that may be performed for facilitating group payment for a selected product and/or service as described above in connection with step 208 of FIG. 2.

At step 400, one or more processors and one or more hardware memories such as a processor and a memory of payment provider server 160 of FIG. 1 may be used to store information such as account information regarding the plurality of users. For example, account information such as financial account information for each of the plurality of users may be stored.

At step 402, an indication of a desire of at least one of the plurality of users to purchase a product and/or service may be received. The indication may be included in the purchase information received at step 208 of FIG. 2.

At step 404, an option for sharing payment for the product and/or service may be provided (e.g., sent) to the plurality of users. For example, a group payment option that includes an option for each user to pay a selected portion of a total payment for the product and/or service may be sent electronically to the user devices of the users.

At step 406, an agreement may be received from some or all of the plurality of user for sharing the payment (e.g., an agreement or request from each of the some or all of the plurality of users to pay for a portion of the total payment).

At step 408, a transfer of funds to a seller account such as a merchant account from accounts of the some or all of the plurality of users who agree to share the payment may be facilitated (e.g., by the payment provider server). In this way, the group payment for the product and/or service may be facilitated.

One or more of the processes and steps described in connection with FIGS. 2, 3, and 4 may be performed in any suitable order, omitted, and/or repeated any suitable number of times for facilitating group-check in and associated processes.

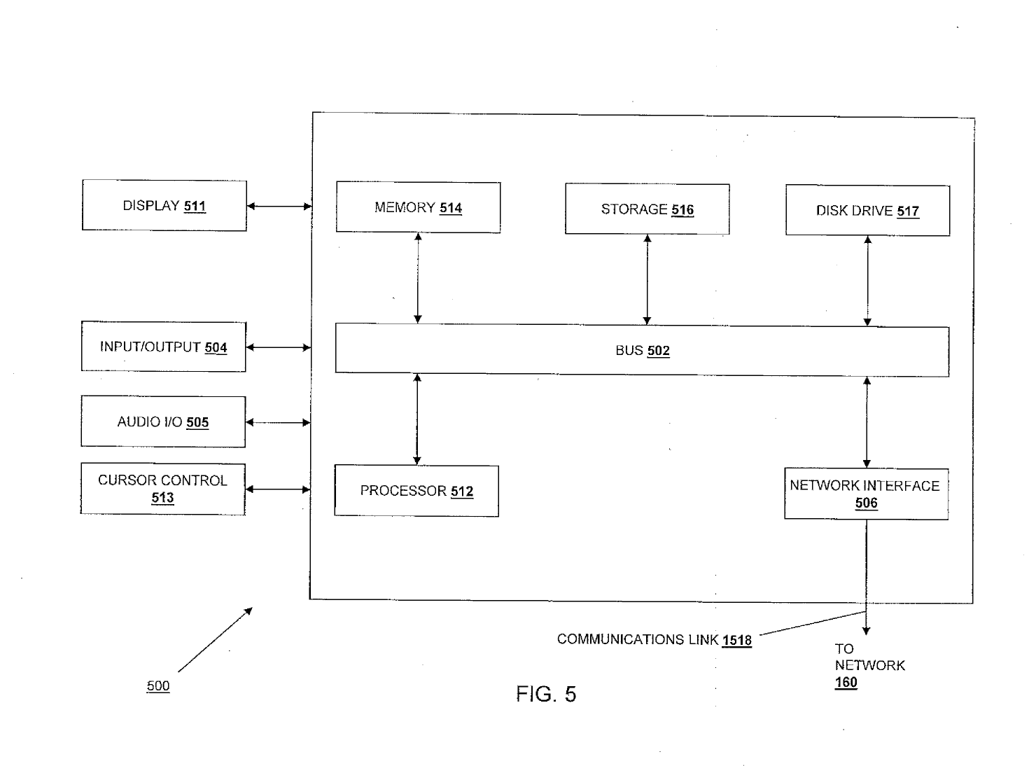

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

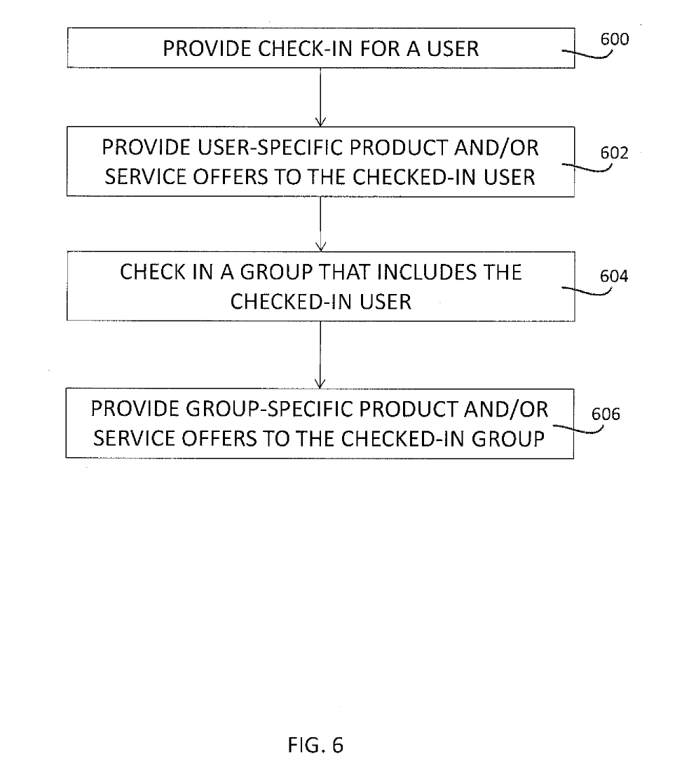

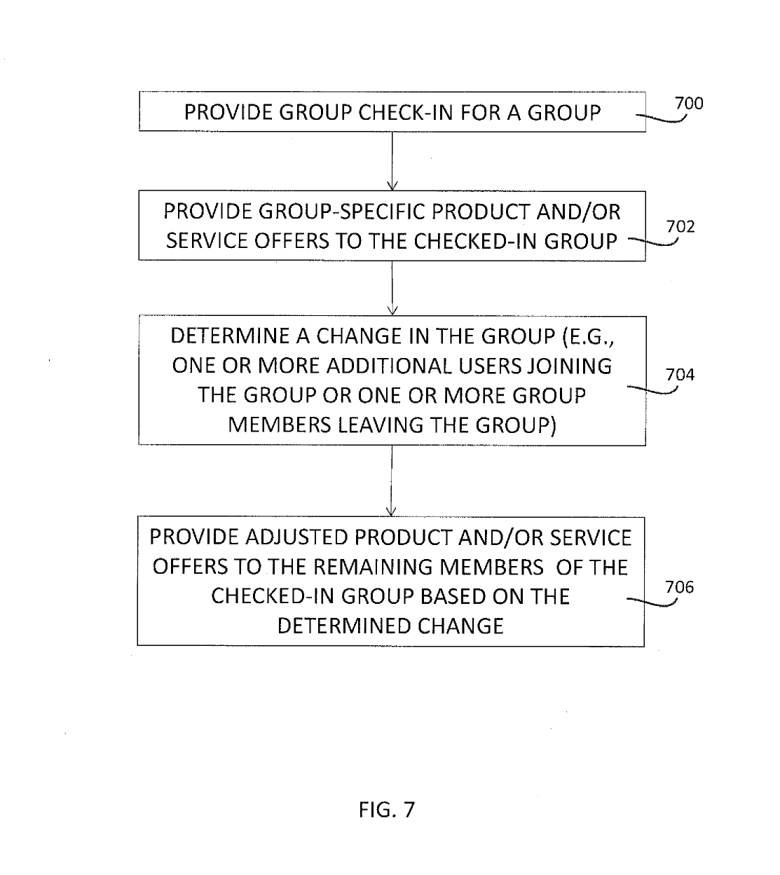

Group-specific product and/or service offers can be tailored to each checked-in group and can differ substantially from user-specific product and/or service offers for individual users. A group check-in system may be provided with the capability of modifying and/or updating product and/or service offers for users when the group status of each user changes. FIGS. 6 and 7 illustrate exemplary processes for modifying and/or updating product and service offers when changes in the group status of one or more checked-in users or groups are detected.

Illustrative steps that may be performed for modifying and/or updating product and service offers when a checked-in user becomes a member of a checked-in group are shown in FIG. 6.

At step 600, a user may be checked in to a location (e.g., using check-in information such as a user identifier for the user provided through a social media application or website or received from a beacon corresponding to the location when a user device of that user is in communication with the beacon).

At step 602, user-specific product and/or service offers may be provided to the checked-in user. The user-specific product and/or service offers may include offers for products and/or services based on the user's gender, age, purchase history, or other user information. For example, a 25 year old male checked in to a venue during a sporting event may be offered team apparel or a beer package. As another example, a 75 year old woman checked in at a merchant may be offered help carrying items for purchase.

At step 604, a group may be checked in that includes the checked in user. For example, one or more other users may check in to the location to which the user is already checked in (e.g., a friend, a family member or a spouse of the user may arrive at the location after the checked in user). The group may be checked in using any of the systems and/or methods described herein.

At step 606, group-specific product and/or service offers may be provided to one or more members of the checked in group. For example, the spouse of the 25 year old male at the sporting event may later check into the event venue and the group including the 25 year old male and his spouse may be checked in and may receive couple-specific product and/or service offers such as seat upgrade offers, matching apparel offers, etc. that are different from the team apparel or beer package offers provided to the individual user. As another example, the son and daughter of the 75 year old woman may later check into the merchant and the family group including the 75 year old woman and her children may be checked in and may receive family-specific product and/or service offers such as bulk discounts rather than the carry assistance offered to the individual user.

Illustrative steps that may be performed for modifying and/or updating product and service offers when one or more members of a checked-in group leaves the group (e.g., by checking out of the location) are shown in FIG. 7.

At step 700, group check-in may be provided for a group. The group may be checked in using any of the systems and/or methods described herein.

At step 702, group-specific product and/or service offers may be provided to one or more members of the checked in group. As examples, the checked-in group may include a family with children checked into a restaurant or a merchant and the group-specific product and/or service offers may include offers for family-related items such as meal deals or movie rentals.

At step 704, a change in the group may be determined (e.g., one or more additional users joining the group or one or more group members leaving the group). The change may be determined by detecting check-in of additional group members or by detecting check out of one or more group members.

At step 706, adjusted product and/or service offers may be provided to the remaining members of the group based on the determined change. For example, all of the members of the checked-in family except for the father may leave the restaurant and the father may be offered a discount on additional drinks. In another example, the children of the family may leave to go to bed and the parents may be provided with adult-themed products. In another example, the parents may leave a teenager at the merchant to shop elsewhere and the teenager may be provided with offers for music or concert tickets (e.g., a download of Miley Cyrus or Justin Bieber music).

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a hardware memory storing account information for each of a plurality of users; and
one or more hardware processors in communication with the hardware memory and configured to:
receive check-in information from the plurality of users at a location;
identify a group based on the check-in information;
determine an offer for the identified group; and
provide the offer to the identified group.

2. The system of claim 1, wherein the one or more hardware processors are configured to receive a portion of the check-in information from at least one beacon corresponding to the location when a user device of each of the plurality of users is in communication with the at least one beacon.

3. The system of claim 2, wherein each user device is in proximity to the at least one beacon and in communication with the at least one beacon using one of near field communication, radio communication, infrared communication, Bluetooth communication, and Bluetooth low energy communication.

4. The system of claim 1, wherein the group comprises at least two of the plurality of users.

5. The system of claim 4, wherein the group comprises a family, a team, a couple, a club, or a group of friends.

6. The system of claim 4, wherein the one or more hardware processors are further configured to determine a relationship between the at least two of the plurality of users based on the check-in information.

7. The system of claim 6, wherein the one or more hardware processors are configured to identify the group based on the determined relationship.

8. A method comprising:
receiving, electronically by one or more hardware processors, check-in information from a plurality of users at a location;
identifying, electronically by the one or more hardware processors, a group based on the receiving;
determining, electronically by the one or more hardware processors, an offer for the group based on the identifying; and
providing the offer to the group.

9. The method of claim 8, wherein the identifying comprises determining a relationship between at least two of the plurality of users based on the receiving.

10. The method of claim 9, further comprising receiving purchase information associated with the offer from at least one of the plurality of users.

11. The method of claim 10, further comprising facilitating a group payment for a product or service associated with the purchase information.

12. The method of claim 11, wherein the facilitating comprises:
receiving an agreement from some or all of the plurality of users to share a payment; and
facilitating a transfer of funds to a seller account from an account of each of the some or all of the plurality of users.

13. The method of claim 8, wherein the group comprises a family, a team, a couple, a club, or a group of friends.

14. The method of claim 8, wherein the receiving comprises receiving an identifier from a user device of each of the plurality of users.

15. The method of claim 14, wherein the receiving of the identifier from at least one of the user devices comprises receiving that identifier from at least one beacon corresponding to the location when that user device is in communication with the at least one beacon.

16. A non-transitory computer readable medium comprising a plurality of machine-readable instructions which when executed by one or more processors of a server are adapted to cause the server to perform a method comprising:
receiving check-in information from a plurality of users at a location;
identifying a group based on the receiving;
determining an offer for the group based on the identifying; and
providing the offer to the group.

17. The non-transitory computer readable medium of claim 16, wherein the receiving comprises receiving at least some of the check-in information through a social media application.

18. The non-transitory computer readable medium of claim 16, wherein the determining comprises determining a product that is desirable to the group.

19. The non-transitory computer readable medium of claim 18, wherein the providing comprises offering the product for sale to the group.

20. The non-transitory computer readable medium of claim 19, wherein the method further comprises facilitating a group payment for the product.
